(19) United States
(12) Patent Application Publication
(10) Pub. No.: US 2020/0151198 A1
(43) Pub. Date: May 14, 2020

(54) Method of Building Semantic Multi-dimensional Database

(71) Applicant: Wen WANG, Shanghai (CN)

(72) Inventor: Wen WANG, Shanghai (CN)

(21) Appl. No.: 16/422,734

(22) Filed: May 24, 2019

(30) Foreign Application Priority Data
Nov. 8, 2018 (CN) 201811322528.5

(51) Int. Cl. G06F 16/28; G06F 16/22

(52) U.S. Cl. CPC G06F 16/283; G06F 16/2282; G06F 16/2264

(57) ABSTRACT

A method of building Semantic Multi-dimensional Database is disclosed. The method includes: building the main architecture of fact table using a dozen of Universal Dimensions which are abstracted from the real world with semantic principles; building the Coordinates of Meaning to accurately position the meaning of each dimension in every specific scenario, while the Coordinates of Meaning are comprised of three sub-dimensions, i.e. attribute, master data, and instance, totally named as Triangular Sub-dimensions, and are built technically through Dimension Table Family, which is a set of data tables with specific structure; building Dimension Column Family within each dimension of the fact table; building the remaining part of the fact table with a few concise key figures, which are abstracted from quantifiers in business scenarios; and building within each key figure of the fact table the Key Figure Column Family, which is used to store numerals and measures separately. The database built through this invention provides a universal data structure for diversified applications, hence saves considerable time in application development and maintenance, while the data in it is more compatible, self-explainable, and readable.

### TECHNICAL FIELD

This invention relates to database management technology and data warehouse technology, and more specifically, to technology of building Semantic Multi-dimensional database.

### BACKGROUND

The existing data storage technologies, such as relational database management system (RDBMS), data warehouse, and NoSQL database and so on, all demand program developers to design and realize unique data structure for their specific applications, in the process of application development. These data structures may comprise different forms of data tables, data elements, data fields, and the association among them, etc.

Using business applications, such as enterprise resource planning (ERP), customer relationship management (CRM), and enterprise performance management (EPM), as examples, the quantity of uniquely-designed data tables for each application varies from hundreds to tens of thousands. Considering the different kinds of inter-relationships among them, the data structures usually become very complicated. The labor of designing and realizing the data structure not only consumes a large amount of time and efforts of developers, but also impairs the compatibility, maintainability of these application software, and transferability and deployment to the cloud.

To solve these issues, this invention discloses a method of building Semantic Multi-dimensional Database.

### SUMMARY

The technical purpose of this invention is to provide a method of building Semantic Multi-dimensional Database, which provides universal data structure applicable to most business applications, and is easy to develop and maintain, while the database is more compatible, self-explanatory, readable and easily migrated and deployed to the cloud.

To solve these issues, this invention discloses a method of building Semantic Multi-dimensional Database, comprising:

based on a dozen of Universal Semantic Dimensions, which are abstracted from the real world with semantic principles, building the main architecture of fact tables;

building the Coordinates of Meaning to accurately position the meaning of each dimension in every specific scenario, while the Coordinates of Meaning for a specific dimension are comprised of the following three sub-dimensions, named as Triangular Sub-dimensions:

Sub-dimension 1, Attribute: Attributes are subdivisions of different kinds of categories, layers and directions in the dimension;

Sub-dimension 2, Master Data: Master data are individuals of different kinds of forms and granularities, within the dimension;

Sub-dimension 3, Instance: Instances are different kinds of single occurrences of events, transactions, activities, etc., within the dimension;

technically, according to actual demands, building the Coordinates of Meaning with a set of specifically structured data tables, named as Dimension Table Family;

building, under each dimension in the fact table, the Dimension Column Family, which comprises: sub-dimension column, code column, name column, etc.;

linking the dimensions in the fact table with their Dimension Table Families, through sub-dimension column and code column, therefore realizing the accurate positioning for the meaning of the data, which represents specific scenarios in the fact table, through the Coordinates of Meaning;

building the remaining part of the fact table with a few concise key figures, which are abstracted from quantifiers in business scenarios;

Building Key Figure Column Family under each key figure in fact tables, the Key Figure Column Family comprises: amount/quantity, unit of measure, and other columns, which are used to store numerals and measures separately.

In the embodiments of the invention, the Universal Semantic Dimensions comprises: Event; Organization; People; Location; Thing, service, and activity; Project; Account and indicator; Condition; Time; Version; Disease, etc., and several user-definable free dimensions;

Wherein the Dimension Column Family also comprises: Counter-sub-dimension, Counter-code, Counter-name, etc., while non-counter columns are used to store active objects and counter columns are used to store passive objects;

said concise key figures comprises: Amount in transaction currency, Amount in local currency, quantity, price, etc., and several user-definable free key figures; wherein several text columns are also built into the fact table as special key figures.

In accordance with one embodiment, the Dimension Table Family comprises: Table of attributes, Table of master data, and Table of instances, wherein, in one said Semantic Multi-dimensional Database of a specific scenario, such dimensions comprises one or more of Table of attributes, and/or Table of master data, and/or Table of instances.

In accordance with an embodiment, the table of master data refers to the table of attributes, therefore associating the master data in the table of master data with the attributes in the table of attributes, forming new master data in the table of master data, and extending the scale of master data in the table of master data.

In accordance with an embodiment, the table of instances refers to the table of attributes, therefore associating the instances in the table of instances with the attributes in the table of attributes, forming new instances in the table of instances, and extending the scale of instances in the table of instances; wherein the table of instances also refers to the table of master data, therefore associating the instances in the table of instances with the master data in the table of master data, forming new instances in the table of instances, and extending the scale of instances in the table of instances.

In accordance with an embodiment, the table of attributes comprises: attribute code column and attribute name column, and the attribute code column corresponds to the code column in each dimension, therefore associating the data in the fact table with the attributes in the table of attributes.

In accordance with an embodiment, the table of master data comprises: master data code column, name column, and attribute column, and the master data code column corresponds to the code column in each dimension, therefore associating the data in the fact table with the master data in the table of master data, and the attribute column is used for the table of master data to refer to the table of attributes.

In accordance with an embodiment, the table of instances comprises: instance code column, name column, attribute column, and master data column, and the instance code column corresponds to the code column in each dimension, therefore associating the data in the fact table with the instances in the table of instances, and the attribute column is used for the table of instances to refer to the table of attributes, and the master data column is used for the table of instances to refer to the table of master data.

In accordance with an embodiment, the Dimension Table Family further comprises: tree table of attributes, tree table of master data, and tree table of instances, while the tree table of attributes being used to store the inter-relationship among attributes, the tree table of master data being used to store the inter-relationship among master data, and the tree table of instances being used to store the inter-relationship among instances.

In this invention, sub-dimension column, code column, and name column are non-counter columns.

Except where the context indicates otherwise, words in the singular include the plural, and vice versa.

With the above technical solutions, this invention, compared with existing techniques, has the following advantages and positive effects:

(1) this invention can be applied to different kinds of applications and scenarios, by building the main architecture of the fact table with a dozen of Universal Dimensions, which are abstracted from the real world with semantic principles,

and the Coordinates of Meaning can accurately position the particular meaning of each dimension in a specific scenario, by building the Triangular Sub-dimensions which can quickly position the specific meaning of each corresponding dimension in a specific scenario precisely,
and the data storage structure in each dimension of the fact table can be determined quickly, by building Dimension Column Family to form the structure in each dimension of the fact table,
and, build concise key figures to form the main structure of the quantifiers in the fact table, and build the Key Figure Column Family to form the specific structure of the key figures of the fact table to determine the data storage structure of the quantifiers in the fact table quickly,
and the Semantic Multi-dimensional Database of this invention realizes the technical effects of being easy to develop and maintain the database, more universal and economical;

(2) From the Dimension Table Family, this invention builds the Table of attributes, Table of master data, and Table of instances, each of which is a direction to position the accurate meaning of a dimension in a specific scenario. Furthermore, Table of master data can refer to Table of attributes, and Table of instances can refer to Table of attributes and Table of master data, hence preventing the isolation of these three sub-dimensions, and altogether, they realize the technical effect of a broad and accurate Coordinates of Meaning, which in turn contributes to a database with high generality;

(3) through the Dimension Column Family, which comprises sub-dimension column, code column, name column, and counter columns, wherein the sub-dimension column is used to link the data in the fact table to that of table of attributes, table of master data, and table of instances in the Dimension Table Family respectively, and wherein the code column is used to link the data in the fact table to the specific attribute, master data, or instance in the Dimension Table Family, hence increasing the associations between these tables and being convenient to the storage, query and maintenance of the database, and wherein the counter columns enrich the data in the database and the associations among the columns, and altogether they realize the technical effects of readability, and self-explanatoriness;

(4) through free dimensions and free key figures, both of which are editable and user-definable, this invention enhances the technical effects of the generality of the database.

### BRIEF DESCRIPTION OF THE DRAWINGS

FIG. 1 is a block diagram that illustrates this method of building the Semantic Multi-dimensional Database;

FIG. 2 is a general structure that illustrates the architecture of the Semantic Multi-dimensional Database in this invention;

FIG. 3 is a block diagram that illustrates the structure of one Dimension Table Family in this invention;

FIG. 4 is a table that illustrates the method of building the Semantic Multi-dimensional Database in one embodiment of financial report consolidation application;

FIG. 5 is a block diagram that illustrates an example of the Dimension Table Family of the “Event” dimension in FIG. 4;

FIG. 6 is a block diagram that illustrates an example of the Dimension Table Family of the “Organization” dimension in FIG. 4;

FIG. 7 is a table that illustrates an example of the fact table in the Semantic Multi-dimensional Database in another embodiment of planning and budgeting application;

FIG. 8 is a block diagram that illustrates an example of the Dimension Table Family of the “Thing, service, and activity” dimension in FIG. 7;

FIG. 9 is a table that illustrates an example of the fact table in the Semantic Multi-dimensional Database in another embodiment of activity-based costing (healthcare industry) application;

FIG. 10 is a block diagram that illustrates an example of the Dimension Table Family of the “Disease” dimension in FIG. 9;

FIG. 11 is a block diagram that illustrates an example of the Dimension Table Family of the “Thing, service, and activity” dimension in FIG. 9.

### DETAILED DESCRIPTION

Features, aspects, and advantages of the presently disclosed technology will be better understood in accordance with the following description, appended claims, and accompanying drawings.

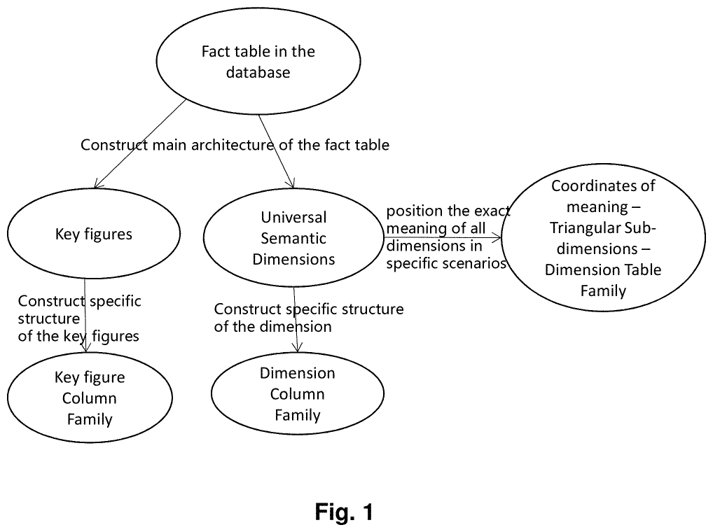

FIG. 1 shows a method of building a Semantic Multi-dimensional Database, comprising:

building the main architecture of the fact table, with a dozen of Universal Semantic Dimensions, which are abstracted from the real world with semantic principles and comprise: Event; Organization; People; Location and facility; Thing, service, and activity; Project; Account and indicator; Condition; Time; Version; Disease, etc., and several user-definable free dimensions;

preferably, in the Semantic Multi-dimensional database in any specific scenario, the Universal Semantic Dimensions comprises one or more of above items, i.e. it is not necessary for the Universal Semantic Dimensions to comprise all of them, but just comprise what is needed in the specific scenario;

building the Coordinates of Meaning to accurately position the meaning of each dimension in every specific scenario, while the Coordinates of Meaning are comprised of the following three sub-dimensions, named as Triangular Sub-dimensions:

Sub-dimension 1, Attribute: Attributes are the subdivisions of different kinds of categories, layers, and directions in the dimension;

Sub-dimension 2, Master Data: Master data are individuals of different kinds of forms and granularities, within the dimension;

Sub-dimension 3, Instance: Instances are different kinds of single occurrences of events, transactions, activities, etc., within the dimension;

technically, building the Coordinates of Meaning with a set of specifically structured data tables, named as Dimension Table Family, which comprises: Table of attributes, Table of master data, and Table of instances;

preferably, in the Semantic Multi-dimensional database in any specific scenario, the Dimension Table Family in each dimension comprises one or more of Table of attributes, and/or Table of master data, and/or Table of instances, i.e. it is not necessary for the Dimension Table Family to comprise all the sub-dimensions, but just comprise what is necessary for the requirements of accurate positioning of the meaning in the dimension;

preferably, the table of master data refer to the table of attributes, therefore associating the master data in the table of master data with the attributes in the table of attributes, forming new master data in the table of master data, and extending the scale of master data in the table of master data, optionally, a master data may refer to one or multiple attributes.

preferably, the table of instances refer to the table of attributes, therefore associating the instances in the table of instances with the attributes in the table of attributes, forming new instances in the table of instances, and extending the scale of instances in the table of instances, and the table of instances also refer to the table of master data, therefore associating the instances in the table of instances with the master data in the table of master data, forming new instances in the table of instances, and extending the scale of instances in the table of instances, optionally, an instance may refer to one or multiple attributes; or, an instance may refer to one or multiple master data.

preferably, the Dimension Table Family further comprises: tree table of attributes, tree table of master data, and tree table of instances, while the tree table of attributes being used to store the inter-relationship among attributes, the tree table of master data being used to store the inter-relationship among master data, and the tree table of instances being used to store the inter-relationship among instances;

building, under each dimension in the fact table, the Dimension Column Family, which comprises: sub-dimension column, code column, name column, counter-sub-dimension column, counter-code column, counter-name column, etc., while, according to semantic principle, non-counter columns are used to store active objects and counter columns are used to store passive objects;

Preferably, the columns in the Dimension Column Family to be built only need to meet the requirements of the fact table, the irrelevant ones can be ignored to simplify the fact table;

linking the dimensions in the fact table with their Dimension Table Families, through sub-dimension column and code column, therefore realizing the accurate positioning for the meaning of the data, which represents specific scenario in the fact table, through the Coordinates of Meaning;

preferably, the table of attributes comprises: attribute code column and attribute name column, and the attribute code column corresponds to the code column under each dimension, therefore associating the data in the fact table with the attribute in the table of attributes;

preferably, the table of master data comprises: master data code column, name column, and attribute column, and the master data code column corresponds to the code column under each dimension, therefore associating the data in the fact table with the master data in the table of master data, and the attribute column is used for the table of master data to refer to the table of attributes;

preferably, the table of instances comprises: instance code column, name column, attribute column, and master data column, and the instance code column corresponds to the code column under each dimension, therefore associating the data in the fact table with the instances in the table of instances, and the attribute column is used for the table of instances to refer to the table of attributes, and the master data column is used for the table of instances to refer to the table of master data;

building the remaining part of the fact table with a few concise key figures, which are abstracted from quantifiers in business scenarios and comprise: Amount in transaction currency, Amount in local currency, quantity, price, etc., and several user-definable free key figures, and also building several text columns into the fact table as key figures;

building, under each key figure in the fact table, the Key Figure Column Family, which comprises: amount/quantity, unit of measure, and other columns, and is used to store numerals and measures separately;

preferably, it is not necessary to comprise all the figures in key figures above or the columns in the Key Figure Column Family above, but just comprise what is needed in the specific scenario.

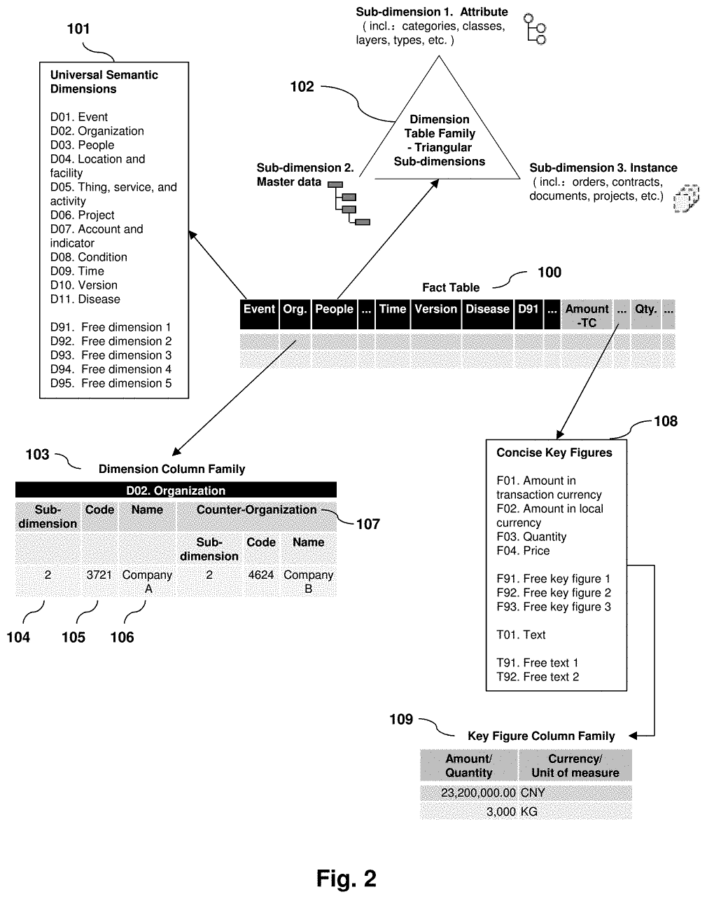

FIG. 2 shows the architecture of the Semantic Multi-dimensional Database in order to provide a thorough understanding of the embodiments of this invention:

100: The fact table is at the core of the Semantic Multi-dimensional Database, which is similar to that (those) in the data warehouse and also comprises columns of the dimensions and key figures.

101: Contrary to freely definable dimensions, most of the dimensions in the Semantic Multi-dimensional Database have abstract business meaning respectively. As shown in table 1, the embodiments comprise 11 universal dimensions: Event; Organization; People; Location and facilities; Thing, service, activity; Project; Accounts and indicators; Condition; Time; Version; and Disease. In a specific Semantic Multi-dimensional database, the fact table may comprise one or more of the universal dimensions above in order to realize the data storage. The redundant ones may not be included in the fact table.

TABLE 1
Universal Dimensions

| Dimension | | Dimension | |
|---|---|---|---|
| Code | Name | Code | Name |
| D01 | Event | D02 | Organization |
| D03 | People | D04 | Location and facility |
| D05 | Thing, service, | D06 | Project |
| | and activity | | |
| D07 | Account and indicator | D08 | Condition |
| D09 | Time | D10 | Version |
| D11 | Disease | | |

The universal dimensions are abstracted from different kinds of complicated business scenarios according to semantic principles. As a result, they are widely applicable and named as “Universal Semantic Dimensions”. Furthermore, to be more adaptive to some special user scenarios, several free dimensions are also built into the fact table in the embodiments.

102: In the Semantic Multi-dimensional Database, a set of specifically structured tables are associated with each dimension in the fact table, named as Dimension Table Family. Dimension Table Family can flexibly position the accurate meaning of the dimension in any specific business scenario through 3 inter-related sub-dimensions, named as “Triangular Sub-dimensions”.

The three sub-dimensions are Attribute, Master data, and Instance respectively. They are defined as following:

Attributes are the subdivisions of different kinds of categories, layers and directions in the dimension, such as place of origin, color, voltage level, etc., and attributes may be organized in different kinds of tree structures;

Master data are individuals of different kinds of forms and granularities, within a dimension, such as a company, a group company, a person, a product, etc., and master data may be organized in different kinds of tree structures too;

Instances are different kinds of single occurrences of events, transactions, activities, etc., within a dimension, such as a purchase order, a sales order, an accounting document, a project, an episode in hospital, etc.

In the database, the three sub-dimensions are implemented by Table of attributes, Table of master data, and Table of instances, which are used to store attributes, master data, and instances in the database, respectively: Table of attributes are used to store the representation forms of the attributes of the subdivisions of different kinds of categories, layers, and directions in a dimension; Table of master data are used to store the representation forms of the master data of the individuals of different kinds of forms and granularities in a dimension; Table of instances are used to store the representation forms of the instances of different kinds of single occurrences of events, transactions, activities, etc. in a dimension.

103: In the Semantic Multi-dimensional Database, each dimension of the fact table comprises not just one single column, but a group of specifically structured columns, named as Dimension Column Family.

104: Dimension Column Family may include the sub-dimension column, which is used to associate the representation forms of the data in the dimension in the fact table with one of the tables among table of attributes, table of master data and table of instances in the Dimension Table Family, in order to position the code column in the Triangular Sub-dimensions.

105: Dimension Column Family may include the code column, which is used to associate the representation forms of the data in the dimension in the fact table with the representation forms of the data in the Dimension Table Family, so the code column is associated with the representation forms of the Dimension Table Family.

106: Dimension Column Family may include the name column, in order to enhance the readability and independency of the fact table.

107: Dimension Column Family may include one or more counter columns, which are used to form the opposite relationship or the associated relations, to extend the scale of Dimension Column Family. For example, as for the buyer and the seller in a deal, the counter-column of the seller related column is the buyer related column.

108: In the Semantic Multi-dimensional Database, the fact table uses a few concise key figures, leaving most of the information to be handled by dimensions. In the embodiments, the Concise Key Figures comprise Amount in transaction currency, Amount in local currency, Quantity, Price, and Text. As to a specific Semantic Multi-dimensional Database, the fact table may also include one or several free key figures, in order to implement data storage. The fact table may also include free key figures, adapt to some special business scenario of some users.

109: The Key Figure Column Family is also used for the key figures in the fact table, in order to develop the structure of the key figures in the fact table. In one embodiment, the Key Figure Column Family comprises 2 basic columns, the “Amount/Quantity” column and the “Currency/Unit of measure” column.

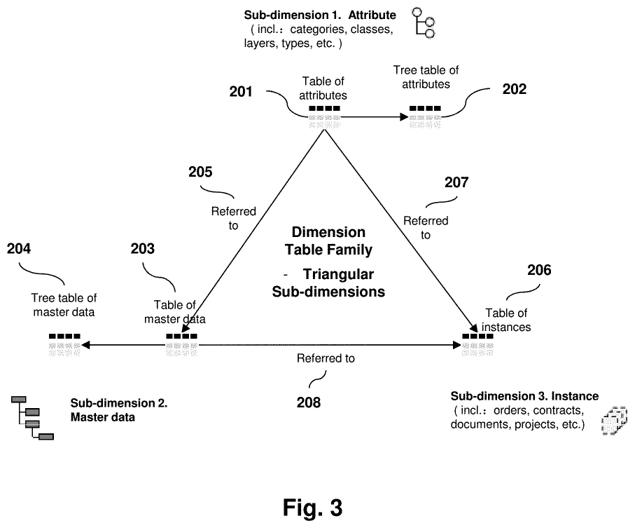

FIG. 3 is a block diagram that illustrates the Dimension Table Family, in order to provide thorough understanding of the embodiments. The purpose of Dimension Table Family is to position the accurate meaning of some dimension in a certain business scenario.

201: Attribute is the first sub-dimension, the most common use of which is to create different kinds of categories and layers within itself. Different attributes may intersect or overlap with each other. The Table of attributes is used to store the codes and representation forms of various attributes of that dimension.

202: Various tree structures of attributes can be stored in the tree table of attributes.

203: Master data is the second sub-dimension, by which the data of the individuals of different kinds of forms and granularities within the dimension, such as a company, a group company, and a department, which are master data within the “organization” dimension, can be stored. The Table of master data is used to store the codes, the representation forms, and various attributes of the master data.

204: Various tree structures can be stored in the tree table of master data.

205: The attributes in the Table of attributes can be referred to by Table of master data in two ways: 1) some important attributes, such as categories, can determine the coding rule and the table structure of the master data; 2) they can be associated with the corresponding attribute fields in the Table of master data.

206: Instance is the third sub-dimension, by which different kinds of single occurrences of events, transactions, activities, etc., such as a purchase order, a sales order, an accounting document, a project, a hospital episode, etc., can be stored. The table of instances stores the codes, representation forms, and various attributes of the instances.

What needs to be mentioned is: the table of instances does not contain the detailed information of the instances (a sales order, for example), such as customer, product, or amount, etc., which can be stored in the fact table. The main purpose of the Dimension Table Family is to position the specific meaning of a specific dimension in a specific scenario, and the attributes in the Table of instances only include the feature in the specific dimension itself, hence the table of instances can't be used to store the detailed information of the instances.

207: Similar to the Table of master data, the Table of instances can refer to the attribute in the Table of attributes.

208: The master data in the Table of master data can also be referred to by the Table of instances. Therefore, instance may be considered as the smallest granularity in the three sub-dimensions.

Based on the above description, three embodiments from different applications are used to explain how this invention can fulfill the data building and storage requirements in various business scenarios with a universal data structure, and its technical features and effects.

### Embodiment 1

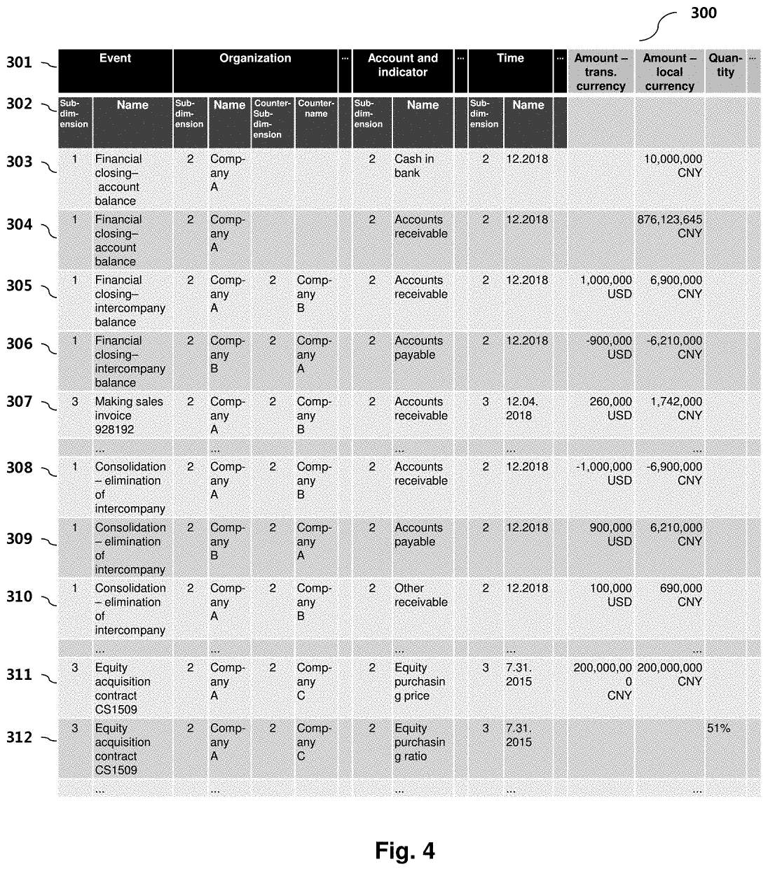

FIGS. 4, 5, and 6 show an embodiment of building and using the Semantic Multi-dimensional Database for the business application of financial report consolidation:

300: The Dimension Table Family, the Dimension, the Dimension Column Family, the Key Figures, and the Key Figure Column Family work altogether, and the fact table of the Semantic Multi-dimensional Database can store all kinds of data and varied granularity levels of data in a financial report consolidation application.

301: To be simple, only 4 dimensions are illustrated in this embodiment: Event, Organization, Account and indicator, and Time.

302: For concision, only certain columns under certain dimensions are illustrated in this embodiment.

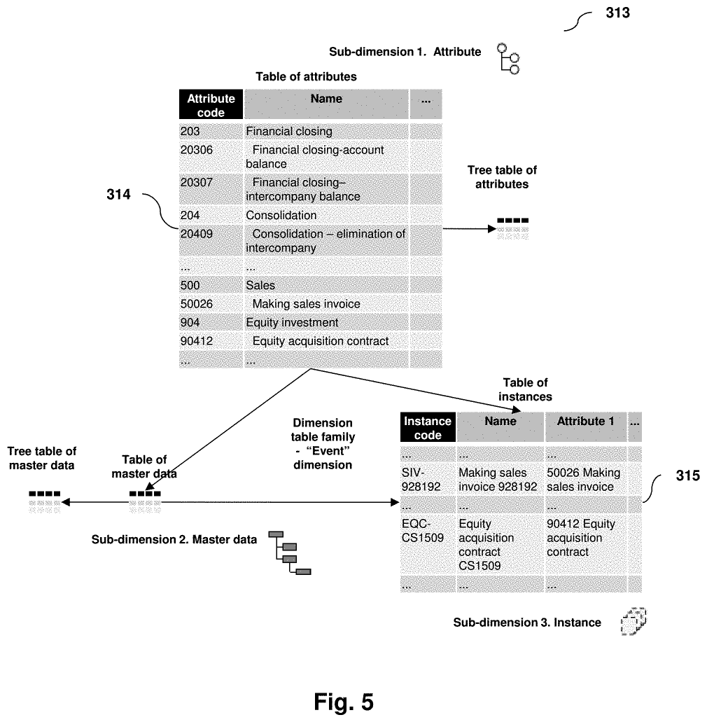

303: The starting point of financial consolidation is the account balances of individual companies after periodic financial closing, which are stated by the event—“Financial closing—account balance” in the fact table, and the sub-dimension is “1 attribute”, corresponding to the classifications and layers of various events in the enterprise (please refer to FIG. 5). The “Organization” is “Company A”, corresponding to the sub-dimension of “2, master data”; and “Account and indicator” is “Cash in bank”, corresponding to the sub-dimension of “2, master data” too.

304: This line is similar to line 303, except that, account balance only is not detailed enough for the “Accounts receivable” account in financial consolidation, and smaller granularity of data is needed.

305: This line stores “Accounts receivable” balance broke down by internal units. Here, the “Event” dimension becomes a specific “Financial closing—intercompany balance”. As for the “Organization” dimension, the “Counter-organization” column is added to store the data of the customer company. Therefore, this line represents the “Accounts receivable” balance of “Company A” from “Company B”. Furthermore, according to business requirements, the amounts are stored in key figures with “Transaction currency” and “Local currency” respectively.

306: This line is similar to line 305. But this time, it is from the side of “Company B” and states the “Accounts payable” to “Company A”.

307: When the intercompany balances from “Company A” and “Company B” are different from each other, the consolidation application will need their detailed invoice data for the function of reconciliation. This line stores a sales invoice which was created by “Company A” to “Company B” on 12 Apr. 2018. Then the sub-dimension here becomes “3, instances”, which declares a specific sales invoice “928192”, along with code and name columns. According to the business requirements, this line can also contain more dimensional information, such as “Thing, service, and activity” information, etc.

Other accounting and financial data can also be stored in this way.

308: The consolidation application can make different kinds of eliminations and adjustments. This line, line 309, and line 310 are the result of the elimination of intercompany receivable and payable between “Company A” and “Company B”. The “Event” dimension here becomes “Consolidation—elimination of intercompany”, with “1, attribute” as the sub-dimension. Usually, the results of elimination will be stored in the form of both consolidation documents and balance change. Line 308 to line 310 are stored by balance change. And when the consolidation documents are stored, the sub-dimension of “Event” becomes “3, instance”, and the data will be stored by the document number.

309: This line is the balance change of “Company B”, as a result of the above-mentioned elimination of intercompany.

310: This line is the balance change for the difference between the intercompany balances between “Company A” and “Company B”, as a result of the above-mentioned elimination of intercompany. According to some specific rule chosen by the user, it is stored in the “Other receivable” account of “Company A”.

Most other elimination and adjustment data of consolidation can also be stored in the same way.

311: For the elimination of investment and equity, the consolidation application needs specific equity trading transaction data, which can be stored directly in the Semantic Multi-dimensional Database, saving the time of designing and realizing other special data structure. In this line, the sub-dimension of the “Event” dimension is “3, instance”, which stores each specific “Equity acquisition contract”. Such contract in this line has a contract number of “CS1509”, which contains the information of “Company A” buying the equity of “Company C”. For “Account and indicator” dimension, the “Equity purchasing price” here is a master data of non-chart-of-account indicator. And the contract date in the “Time” dimension is “7.31.2015”, and the transaction amount is “20,000,000 CNY”.

312: This line records the same equity acquisition contract as in line 311, except it is to store the “51%” “Equity purchasing ratio”, which is another master data of non-chart-of-account indicator in the “Account and indicator” dimension.

FIG. 5 shows an example of the Dimension Table Family of the “Event” dimension, corresponding to the fact table in FIG. 4.

313: In the financial report consolidation application, the “Event” dimension mainly uses the “1, attribute” and “3, instance” sub-dimensions.

314: The Table of attributes of the “Event” dimension stores a complete set of classification system of all kinds of events happening in this enterprise. These events include not only the internal events, such as “203, Financial closing” and “204, Consolidation”, but also the external events, such as “500 Sales” and “904 Equity investment”. This sub-dimension is widely used in the above-mentioned fact table.

315: The consolidation application also needs to store the data of instance-level events, such as the “individual sales invoices” and “equity acquisition contracts” shown in FIG. 4. Their codes, names, and attributes are stored in the Table of instances and are referred to by the fact table.

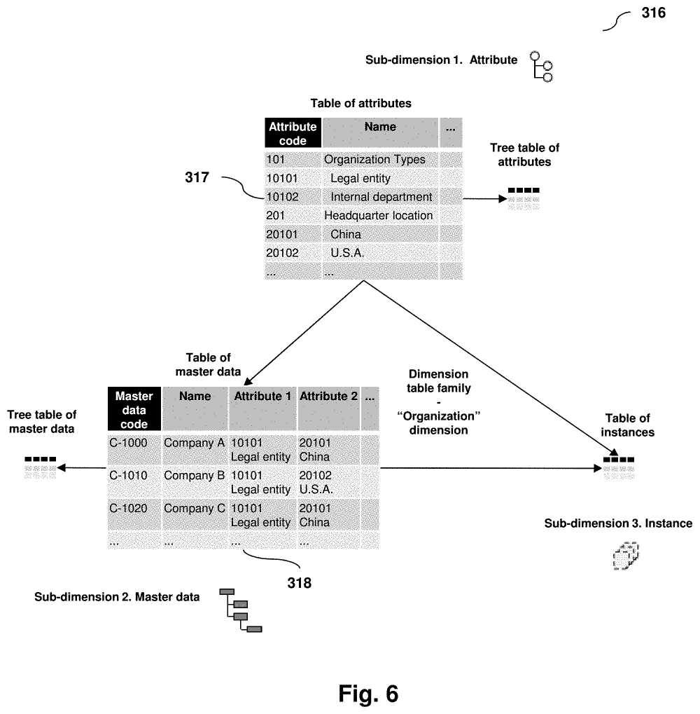

FIG. 6 shows an example of the Dimension Table Family of the “Organization” dimension, corresponding to the fact table in FIG. 4.

316: In the financial report consolidation application, the “Organization” dimension mainly uses the “1, attribute” and “2, master data” sub-dimensions.

317: The attributes of the “Organization” dimension may be very diversified, such as legal entities or internal departments classified by the organization types; or the location of the headquarter as an attribute. Moreover, the “Organization” dimension may contain not only the organizations within an enterprise, but also the organizations out of it, such as customer companies, or supplier companies, etc.

318: The consolidation application mainly uses the master data level data of the “Organization” dimension and stores them in the Table of master data, for example, company A, B, and C, their codes, names, and other attributes, in the fig.

The first embodiment shows that the Semantic Multi-dimensional Database is applicable to the consolidation applications and is flexible and universal. And the following two more embodiments may further illustrate the flexibility and generality of this invention.

### Embodiment 2

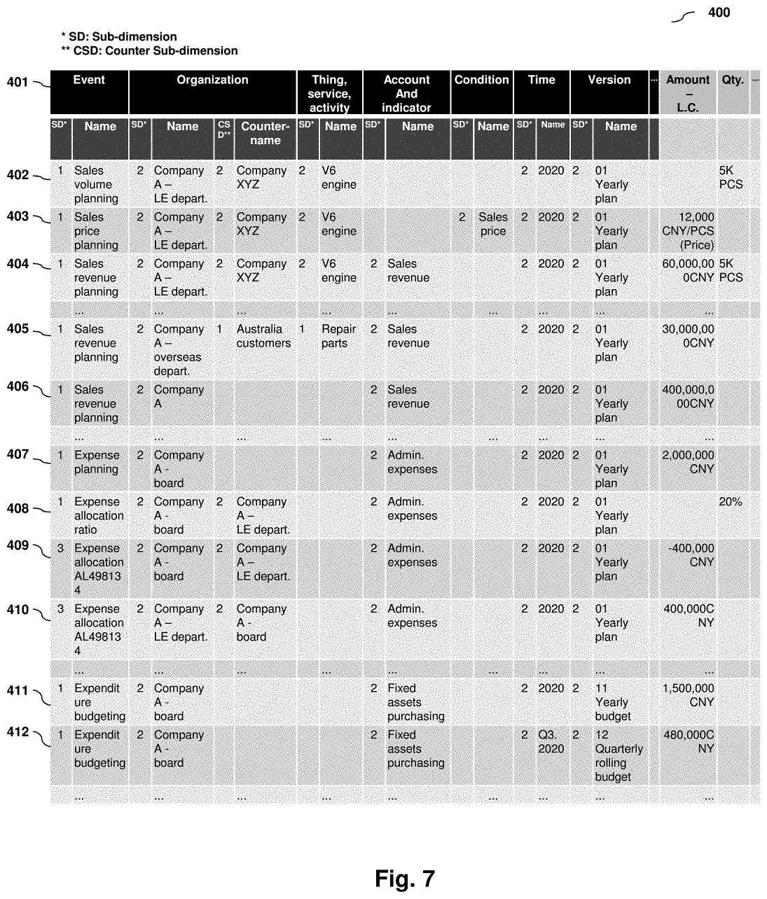

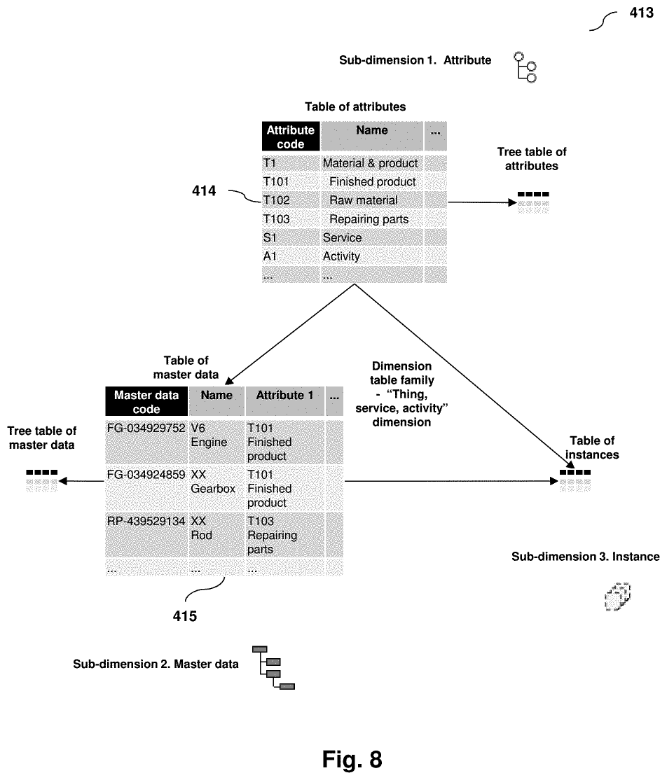

FIGS. 7 and 8 show an embodiment of building the Semantic Multi-dimensional Database for the planning and budgeting application:

400: Because of the differences among organizations, the way and the data granularity of planning and budgeting may vary widely from one organization to another. However, different kinds of planning and budgeting data can be stored through one universal data structure by the method of building the Semantic Multi-dimensional Database.

401: For concision, only 7 dimensions are illustrated in this embodiment: “Event”, “Organization”, “Thing, service, and activity”, “Account and indicator”, “Condition”, “Time”, and “Version”.

402: This line stores the “Sales volume plan” for year 2020, made by “Company A—large enterprise sales department”. Here, the “Organization” dimension is the master data of an internal department in a company. This department plans in small granularity, which requires the detailed plan for every large customer, such as “Company XYZ”, and every product, such as “V6 engine”. Furthermore, the planning data is managed in different versions, one of which is the version “01, yearly plan” in this line. And because this line is “Sales volume planning”, it only contains the quantity (“5,000 PCS”) and no amount.

403: Through the “Condition” dimension, the fact table of Semantic Multi-dimensional Database can store different kinds of price conditions flexibly. This line is part of the “Sales price planning”, which has the same granularity with line 402. The exact “Sales price”, which equals to “12,000CNY/PCS”, is stored in the “Price” key figure of the fact table. The separation of price planning and quantity planning is one of the typical practices in planning and budgeting.

404: Through the calculation of the planning and budgeting application, the “Sales volume planning” in line 402 and the “Sales price planning” in line 403 are combined into the “Sales revenue planning” in this line. This procedure transforms the business plan into the financial plan, so the “Account and indicator” dimension in this line adds a “Sales revenue” account, which belongs to master data of the “Account and indictor” dimension.

405: One notable feature of the planning and budgeting application is that the granularity of its data may vary widely and very flexibly. In this line, when another department, the “Company A—overseas sales department” makes its own sales plan, it only requires the summary data for customer in countries and the summary data for product in categories. Therefore, the “Counter” column of the “Organization” dimension shows “Australia customers”, which belongs to sub-dimension “1, Attributes”; and the “Thing, service, activity” dimension shows “Repair parts”, which also belongs to sub-dimension “1, Attributes”. In such circumstances, master data is no longer the suitable choice for sub-dimension. Moreover, in such granularity, it's not suitable to plan quantity and price separately anymore, so the “Event” dimension becomes “Sales revenue planning” directly, and key figure only contains “Amount”, and no quantity or price.

406: This line is the total “Sales revenue plan” for the entire company of “Company A”.

407: Line 407 to line 410 show an example of expense allocation, which is one usual scenario in planning and budgeting application. This line stores the “Expense planning” result of the “Company A—board of directors” through the “Administration expenses” account.

408: To realize the allocation of expenses, different kinds of allocation standards need to be stored. They can also be stored in the fact table of the Semantic Multi-dimensional Database directly. This line stores the “Expense allocation ratio”, which shows “20%” of “Administration expenses” being allocated from “Company A—board of directors” to “Company A—large enterprise sales department”.

409: After the running of the allocation function, the planning and budgeting application creates an expense allocation document, which is numbered “AL498134”. Line 409 and line 410 store the data of this document, so the sub-dimension of the “Event” dimension becomes “3, instance” here, with the exact code and name representing this “Expense allocation AL498134” document. This line shows “400,000 CNY” “Administration expenses” being allocated from “Company A—board of directors”.

410: This line shows “400,000 CNY” “Administration expenses” being received by “Company A—large enterprise sales department”, which is another line of that expense allocation document.

411: When the complete planning is finished and the expenditure plan within it is transformed into strict expenditure budget, the “Event” dimension becomes “Expenditure budgeting”; the “Version” dimension becomes specific “11, Yearly budget”; and the “Account and indicator” dimension is no longer normal accounts, but a set of specific budgeting accounts, one of which is the “Fixed assets purchasing” account in this line.

412: If “Company A” updates the budget in a quarterly rolling mode, it only needs to add a specific “Version”, such as the “12, Quarterly rolling budget”, and the related data can be stored directly in the universal data structure of the Semantic Multi-dimensional Database. This line is an example of that.

FIG. 8 is an example to show the Dimension Table Family of the “Thing, service, activity” dimension, corresponding to the fact table in FIG. 7.

413: In the planning and budgeting application, the “Thing, service, activity” dimension mainly uses the “1, attribute” and “2, master data” sub-dimensions.

414: The “Thing, service, activity” dimension can have abundant attributes. But for concision, this embodiment only shows a few of the “category” attributes, which are used in FIG. 7, such as the “Repairing parts” sub-category which is within the “Material & product” category. In FIG. 7, some of the planning directly positions to the granularity of the “Repairing parts” attribute.

415: The Table of master data stores the code, name, and attributes of the SKU-level products and parts, which include the “V6 Engine”, etc. in FIG. 7. The attributes in the Table of master data refer to the Table of attributes.

### Embodiment 3

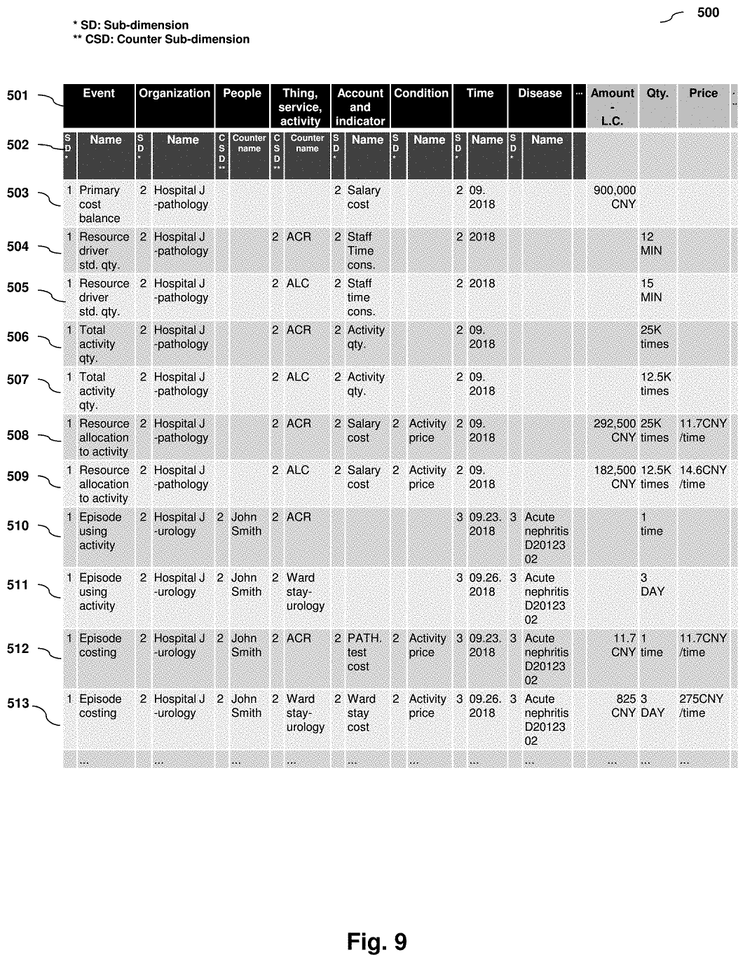

FIGS. 9, 10, and 11 show an embodiment of building the Semantic Multi-dimensional Database for the activity-based costing application for healthcare industry:

500: This embodiment shows how to store all kinds of relevant data directly in the fact table of the Semantic Multi-dimensional Database, when using activity-based costing to collect and allocate costs through activities, in the healthcare industry.

501: For concision, only 8 dimensions are illustrated in this embodiment: “Event”, “Organization”, “People”, “Thing, service, and activity”, “Account and indicator”, “Condition”, “Time”, and “Disease”.

502: In this embodiment, the “counter” columns in the Dimension column family are also important to these two dimensions of “People” and “Thing, service, activity”. The specific meaning of the “counter” columns in a specific scenario is mainly determined by the user based on the semantic of the “Event” dimension.

503: This line shows the “Primary cost balance” of the “Hospital J—pathology department”, with “Salary cost” as the financial account. “Primary cost” is the original status of the costs occurring, which are collected in different relevant departments respectively.

504: In this embodiment, the primary (resource) costs are allocated to different activities through the Resource Driver standard quantity, just stored in line 504 and line 505. As shown in this line, the quantitative standard of “Staff time consumption” for “ACR” activity in the “Hospital J—pathology department” is “12 MIN”. “Staff time consumption” here is the specific quantitative standard of the Resource Driver, which exists as a master data of the “Account and indicator” dimension.

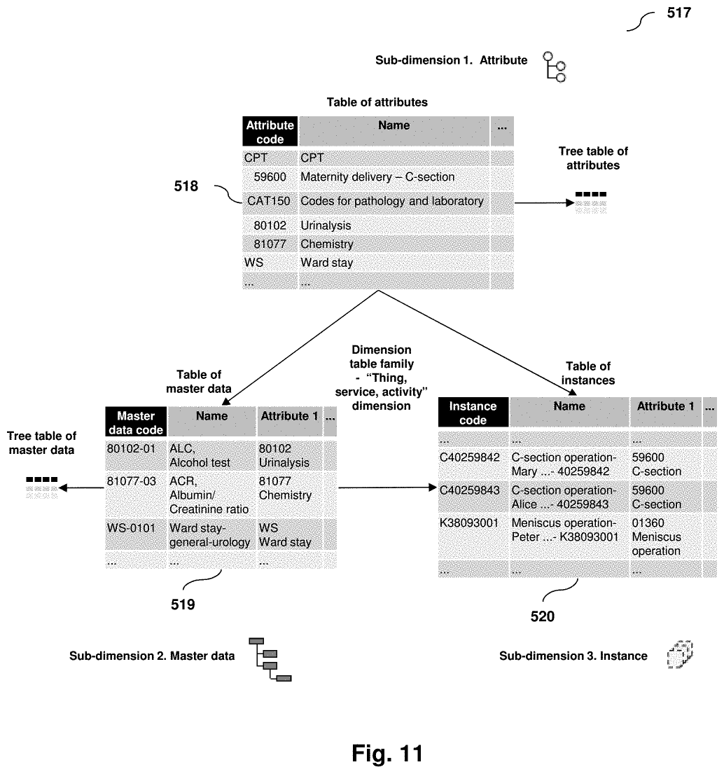

505: This line stores the “quantitative standard of the Resource Driver” of another activity—“ALC”. And the exact meaning of “ACR” and “ALC” will be explained in FIG. 11.

506: The Resource Driver for pathological testing is the “Activity quantity”, so the actual “Activity quantity” of every testing activity done by the “Hospital J—pathology department” is needed. This line is about the “ACR” activity: totally “25,000 times” in “2018.09”.

507: This line shows another activity ALC's “Total activity quantity”.

508: Based on the activity quantity and the quantitative standard (“staff time consumption” in this case), the activity-based costing application calculates the “Activity price” for each activity and allocates the costs to each activity by it.

In this line, the allocation result is stored with the event “Resource allocation to activity”. The “Hospital J—pathology department” is the initiator, and the activity “ACR” is the receiver and hence stored in the counter columns.

The financial account is still “Salary cost”, but the newly-calculated “Activity price” is a price condition, therefore represented by the “Condition” dimension. The activity price of ACR is “11.7 CNY/time”, and a total of “292,500 CNY” costs are allocated to it in “2018.09”.

509: This line shows the result of the “Resource allocation to activity” for another activity—“ALC”.

510: For hospital episodes, when they use various activities, they need to absorb the costs of these activities. It is based on the actual quantity of “Episode using activity” to calculate activity costs absorption.

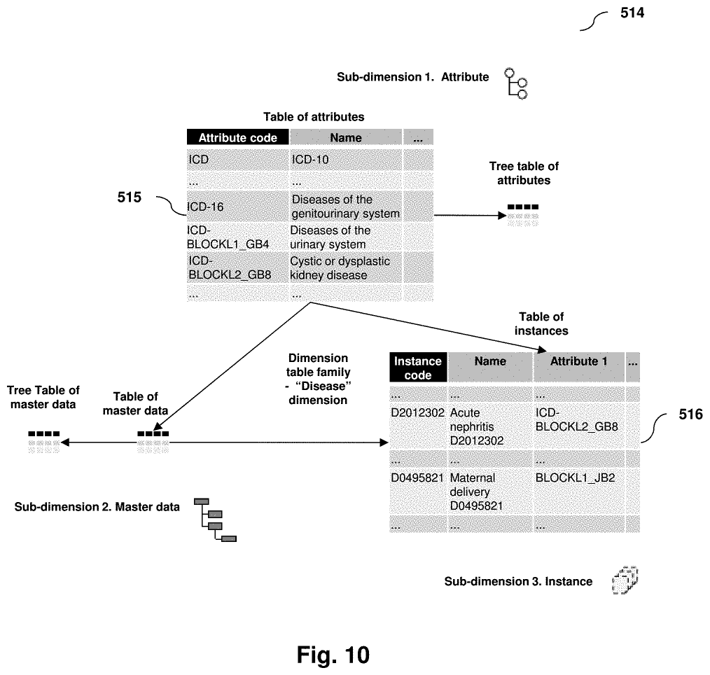

Line 510 and line 511 record the quantities of various activities used by a specific episode, “Acute nephritis D2012302”, for a patient named “John Smith”. For the “Disease” dimension, specific episodes are one kind of instances, so the sub-dimension here is “3, instance” (please refer to FIG. 10).
Furthermore, the “Organization” dimension now becomes “Hospital J—urology department”, which is the attending department of this episode. And “Hospital J—pathology” can be stored in the counter-organization column. Moreover, the patient is stored in the counter-people column, which is determined by the user based on the meaning of this event, and at the same time, the doctor can be stored in the “active voice” column of the “People” dimension.

511: This line shows that the episode “Acute nephritis D2012302” of patient “John Smith” uses “3 DAYs” of the “Ward stay—urology” activity.

512: Based on the above quantities of “Episode using activity” and the calculated “Activity price”, the application calculates the activity costs for each episode and stores the result in this line and line 513. The “Event” dimension of this line is “Episode costing”. This line allocates “11.7 CNY” cost of the “ACR” activity to the episode “Acute nephritis D2012302”, with a secondary cost account, “PATH test cost”, which also belongs to a category in the “Account and indicator” dimension.

513: This line is to allocate the “Ward stay cost” into the episode “Acute nephritis D2012302”.

FIG. 10 shows the Dimension Table Family of the “Disease” dimension, corresponding to the fact table in FIG. 9.

514: In the activity-based costing (healthcare) application, the “Disease” dimension mainly uses the “1, attribute” and “3, instance” sub-dimensions.

515: For the “Disease” dimension, a classification system for all diseases should be maintained in the Table of attributes. This embodiment uses the International Classification of Diseases, “ICD-10” system.

516: Episodes, as the instances of different kinds of diseases, are stored in the Table of instances with the codes, names, and attributes. The Table of instances refers to the classification of diseases in the Table of attributes.

FIG. 11 shows the Dimension Table Family of the “Thing, service, activity” dimension, corresponding to the fact table in FIG. 9.

517: In the activity-based costing (healthcare) application, the “Thing, service, activity” dimension uses all the 3 sub-dimensions of the “Triangular sub-dimensions”.

518: For the healthcare sector, the Table of attributes for

the “Thing, service, activity” dimension is required to maintain a classification system of medical, surgical, and diagnostic services. This embodiment uses the Current Procedural Terminology (CPT) code set maintained by the American Medical Association.

519: For some activities, such as the “ALC, Alcohol test”, “ACR, Albumin/Creatinine ratio”, and “Ward stay-general-urology” used in FIG. 9, the hospital, for the purpose of internal management, has smaller granularity than CPT has, and they are also changed more often. So these activities are stored as “sub-dimension 2, master data”.

520: For some other activities, such as different kinds of surgical operations, they are better managed when cost is accounted separately by each “instance”, i.e. single operation. In such situation, the “sub-dimension 3, instance” is used to store these single operations.

The above three embodiments show that the method of building the Semantic Multi-dimensional Database is universal and widely-applicable to different kinds of business applications, so it can save the time and workload of software developers effectively. Moreover, it can improve the consistency and compatibility of data structures across different business scenarios and different enterprises. Furthermore, along with the development of cloud computing and distributed computing (Sharding, for example), the Semantic Multi-dimensional Database will become more practical and more important. This invention has the following technical effects:

1) Making the application maintenance easier, and saving the maintenance cost;

2) Improving the compatibility for applications, convenient for the development of interfaces and micro-services, and saving the system integration cost;

3) Convenient for the deployment of databases and applications on the cloud or in the distributed mode, and saving the system deployment and migration costs;

4) Making it easier for the designing and developing of universal algorithms, universal functions, or universal interfaces, etc.

5) Improving the readability and self-explanatoriness of the data in a database embedded with semantics.

The embodiments of the invention are described in detail in combination with the attached drawings above, but the invention is not limited to the above-mentioned embodiments. Even if various changes are made to the invention, they still fall within the protection scope of the invention, if they are within the scope of the claims of the invention or their equivalent technologies.

What is claimed is:

1. A method of constructing Semantic Multi-dimensional Database, comprising:
building the main architecture of fact tables based on a dozen of Universal Semantic Dimensions, which are abstracted from the real world with semantic principles;
building the Coordinates of Meaning to accurately position the meaning of each dimension in every specific scenario, while the Coordinates of Meaning are comprised of the following three sub-dimensions mutually, named as Triangular Sub-dimensions, as for a specific dimension, the Coordinates of Meaning comprise:
Sub-dimension 1, Attribute: Attributes are the subdivisions of different kinds of categories, layers and directions in this dimension;
Sub-dimension 2, Master Data: Master data are individuals of different kinds of forms and granularities within this dimension;
Sub-dimension 3, Instance: Instances are different kinds of single occurrences of events, transactions, activities, etc., within this dimension;
technically, according to actual demands, building the Coordinates of Meaning with a set of specifically structured data tables, named as Dimension Table Family;
building, under each dimension in the fact table, the Dimension Column Family, which comprises: sub-dimension column, code column, name column;
linking the dimensions of the fact table with their Dimension Table Families, through sub-dimension column and code column, therefore realizing the accurate positioning for the meaning of the data which represents specific scenarios in the fact table, by the Coordinates of Meaning;
building the remaining part of the fact table with a few concise key figures, which are abstracted from quantifiers in business scenarios;
building Key Figure Column Family under each key figure in the fact table, the Key Figure Column Family comprises: amount/quantity, unit of measure, and other columns, which are used to store numerals and measures separately.

2. The method of claim 1, wherein said Universal Semantic Dimensions comprise: Event; Organization; People; Location and facility; thing, service, and activity; Project; Account and indicator; Condition; Time; Version; Disease, etc., and several user-definable free dimensions;
wherein the Dimension Column Family also comprises columns such as Counter-sub-dimension, Counter-code, Counter-name, etc., said non-counter columns are used to store active objects, while said counter columns are used to store passive objects;
Said concise key figures comprise: Amount in transaction currency, Amount in local currency, quantity, price, etc., and several user-definable free key figures; wherein several text columns are also built into the fact table as special key figures.

3. The method of claim 1, wherein said Dimension Table Family comprises: Table of attributes, Table of master data, and Table of instances, wherein, in one said Semantic Multi-dimensional Database of a specific scenario, said dimensions comprise one or more of Table of attributes, and/or Table of master data, and/or Table of instances.

4. The method of claim 2, wherein said Dimension Table Family comprises: Table of attributes, Table of master data, and Table of instances, wherein, in one said Semantic Multi-dimensional Database of a specific scenario, said dimensions comprise one or more of Table of attributes, and/or Table of master data, and/or Table of instances.

5. The method of claim 3, wherein said table of master data refer to the table of attributes, therefore associating the master data in the table of master data with the attributes in the table of attributes, to form new master data in the table of master data, so as to extend the scale of master data in the table of master data.

6. The method of claim 4, wherein said table of master data refer to the table of attributes, therefore associating the master data in the table of master data with the attributes in the table of attributes, to form new master data in the table of master data, so as to extend the scale of master data in the table of master data.

7. The method of claim 3, wherein said table of instances refers to said table of attributes, therefore associating the instances in the table of instances with the attributes in the table of attributes, to form new instances in the table of instances, so as to extend the scale of instances in the table of instances; wherein said table of instances also refer to the table of master data, therefore associating the instances in the table of instances with the master data in the table of master data, to form new instances in the table of instances, to extend the scale of instances in the table of instances.

8. The method of claim 4, wherein said table of instances refers to said table of attributes, therefore associating the instances in the table of instances with the attributes in the table of attributes, to form new instances in the table of instances, so as to extend the scale of instances in the table of instances; wherein said table of instances also refer to the table of master data, therefore associating the instances in the table of instances with the master data in the table of master data, to form new instances in the table of instances, to extend the scale of instances in the table of instances.

9. The method of claim 5, wherein said table of instances refer to the table of attributes, therefore associating the instances in the table of instances with the attributes in the table of attributes, to form new instances in the table of instances, so as to extend the scale of instances in the table of instances; wherein said table of instances also refers to said table of master data, therefore associating the instances in the table of instances with the master data in the table of master data, to form new instances in the table of instances, so as to extend the scale of instances in the table of instances.

10. The method of claim 6, wherein said table of instances refer to the table of attributes, therefore associating the instances in the table of instances with the attributes in the table of attributes, to form new instances in the table of instances, so as to extend the scale of instances in the table of instances; wherein said table of instances also refers to said table of master data, therefore associating the instances in the table of instances with the master data in the table of master data, to form new instances in the table of instances, so as to extend the scale of instances in the table of instances.

11. The method of claim 3, wherein the table of attributes comprises: attribute code column and attribute name column, and the attribute code column corresponding to the code column in each dimension, therefore associating the data in the fact table with the attributes in the table of attributes.

12. The method of claim 4, wherein the table of attributes comprises: attribute code column and attribute name column, and the attribute code column corresponding to the code column in each dimension, therefore associating the data in the fact table with the attributes in the table of attributes.

13. The method of claim 5, wherein the table of attributes comprises: attribute code column and attribute name column, and the attribute code column corresponding to the code column under each dimension, therefore associating the data in the fact table with the attributes in the table of attributes.

14. The method of claim 6, wherein the table of attributes comprises: attribute code column and attribute name column, and the attribute code column corresponding to the code column under each dimension, therefore associating the data in the fact table with the attributes in the table of attributes.

15. The method of claim 7, wherein the table of attributes comprises: attribute code column and attribute name column, and the attribute code column corresponding to the code column under each dimension, therefore associating the data in the fact table with the attributes in the table of attributes.

16. The method of claim 8, wherein the table of attributes comprises: attribute code column and attribute name column, and the attribute code column corresponding to the code column under each dimension, therefore associating the data in the fact table with the attributes in the table of attributes.

17. The method of claim 9, wherein the table of attributes comprises: attribute code column and attribute name column, and the attribute code column corresponding to the code column under each dimension, therefore associating the data in the fact table with the attributes in the table of attributes.

18. The method of claim 10, wherein the table of attributes comprises: attribute code column and attribute name column, and the attribute code column corresponding to the code column under each dimension, therefore associating the data in the fact table with the attributes in the table of attributes.

19. The method of claim 5, wherein the table of master data comprises: master data code column, name column, and attribute column, and the master data code column corresponding to the code column under each dimension, therefore associating the data in the fact table with the master data in the table of master data, and the attribute column is used for the table of master data to refer to the table of attributes.

20. The method of claim 6, wherein the table of master data comprises: master data code column, name column, and attribute column, and the master data code column corresponding to the code column under each dimension, therefore associating the data in the fact table with the master data in the table of master data, and the attribute column is used for the table of master data to refer to the table of attributes.

21. The method of claim 7, wherein the table of instances comprises: instance code column, name column, attribute column, and master data column, and the instance code column refers to the code column under each dimension, therefore associating the data in the fact table with the instances in the table of instances, and the attribute column is used for the table of instances to refer to the table of attributes, and the master data column is used for the table of instances to refer to the table of master data.

22. The method of claim 8, wherein the table of instances comprises: instance code column, name column, attribute column, and master data column, and the instance code column refers to the code column under each dimension, therefore associating the data in the fact table with the instances in the table of instances, and the attribute column is used for the table of instances to refer to the table of attributes, and the master data column is used for the table of instances to refer to the table of master data.

23. The method of claim 9, wherein the table of instances comprises: instance code column, name column, attribute column, and master data column, and the instance code column refers to the code column under each dimension, therefore associating the data in the fact table with the instances in the table of instances, and the attribute column is used for the table of instances to refer to the table of attributes, and the master data column is used for the table of instances to refer to the table of master data.

24. The method of claim 10, wherein the table of instances comprises: instance code column, name column, attribute column, and master data column, and the instance code column refers to the code column under each dimension, therefore associating the data in the fact table with the instances in the table of instances, and the attribute column is used for the table of instances to refer to the table of attributes, and the master data column is used for the table of instances to refer to the table of master data.

25. The method of claim 5, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.

26. The method of claim 6, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.

27. The method of claim 7, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.

28. The method of claim 8, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.

29. The method of claim 9, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.

30. The method of claim 10, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.

31. The method of claim 11, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.

32. The method of claim 12, wherein the Dimension Table Family further comprises: tree table of attributes, tree table of master data, and tree table of instances, while the tree table of attributes used to store the inter-relationship among attributes, the tree table of master data used to store the inter-relationship among master data, and the tree table of instances used to store the inter-relationship among instances.
